(19) United States
(12) Patent Application Publication
(10) Pub. No.: US 2005/0075948 A1
(43) Pub. Date: Apr. 7, 2005

(54) Customer data collection

(76) Inventors: Todd Sullivan, Wayland, MA (US); John A. Sullivan, Wayland, MA (US)

Correspondence Address: FISH & RICHARDSON PC, 225 FRANKLIN ST, BOSTON, MA, 02110, US

(21) Appl. No.: 10/995,811

(22) Filed: Nov. 23, 2004

Related U.S. Application Data
(63) Continuation of application No. 10/007,107, filed on Dec. 4, 2001.
(60) Provisional application No. 60/251,413, filed on Dec. 5, 2000.
(60) Provisional application No. 60/298,438, filed on Jun. 15, 2001.
(60) Provisional application No. 60/298,429, filed on Jun. 15, 2001.

(51) Int. Cl. G06F 17/60

(52) U.S. Cl. 705/27

(57) ABSTRACT

A method includes displaying a representation of a customizable merchandise item on a marketing screen, the screen having at least one response field for customer data and at least one response field for a customization option, receiving selection data from the customer, the selection data usable for manufacturing the item, updating the displayed representation based on the selection data and receiving a customer response, the response representing customer data.

### DESCRIPTION OF THE DRAWINGS

FIG. 1 is a flowchart showing a customer data collection process.

FIG. 1a is a flowchart of the parties involved in the process of FIG. 1.

FIG. 2 is a flowchart of a first embodiment of a delivery and data distribution process.

FIG. 3 is a flowchart of a second embodiment of a delivery and data distribution process.

FIG. 4 is a customer data collection process implemented on a computer network.

FIG. 4A-4F are exemplary graphical interface windows displayed during the execution of the process of FIG. 1.

FIG. 5 is an example of an item of customized apparel having a temporary covering attached.

### DESCRIPTION

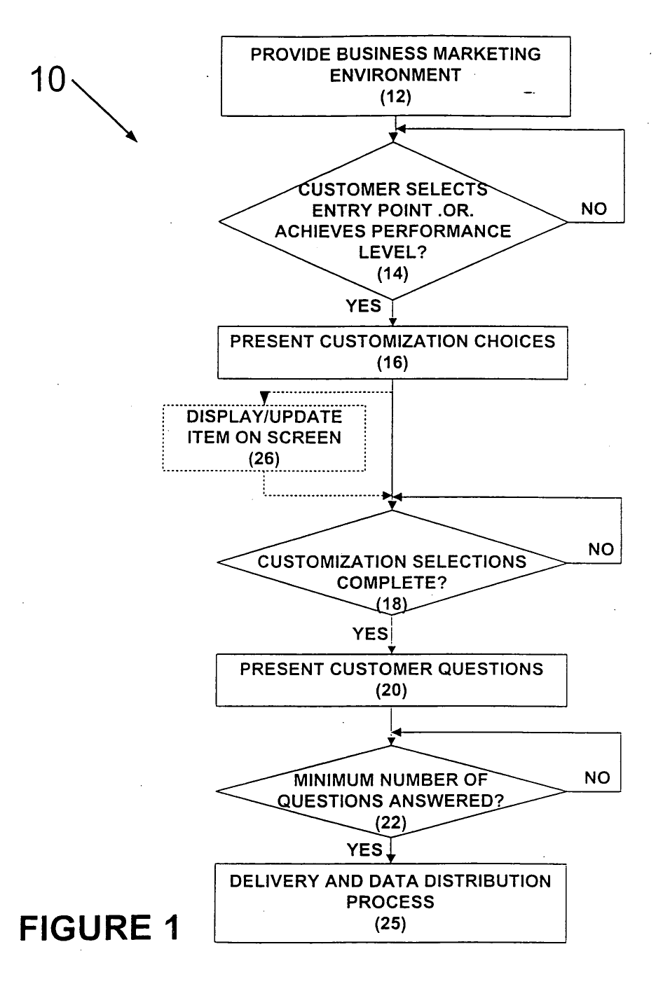

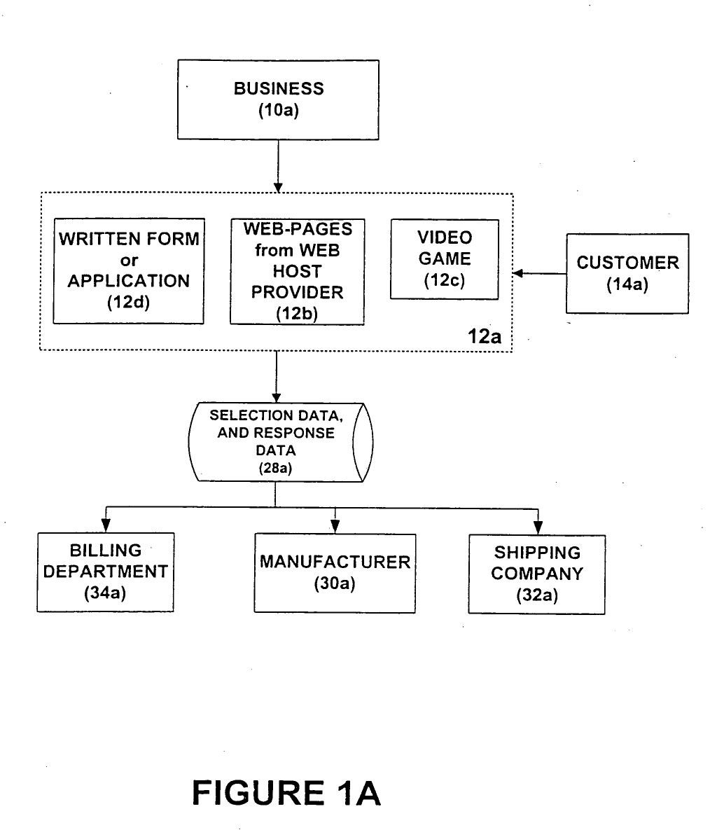

Referring to FIG. 1, a customer data collection process 10 enables a business to collect customer data by enticing a customer to provide responses in exchange for an item of customizable merchandise. Process 10 presents the customer with at least one option that relates to the content or layout of a customizable merchandise item and requires the customer to make a customizing selection. Process 10 also presents the customer with at least one question (or response field) and requires the customer to answer (or respond) with a specified minimum amount of customer information (a response). After the customer has made the customizing selection and provided the response, the merchandise item is manufactured according the customizing selection made and delivered to the customer.

Customizable merchandise refers to any material upon which an image (or text) can be applied, for example, textiles, paper, removable and permanent labels, cardboard (including greeting cards), ceramics, glass, metal, leather, foam and stone.

As used herein, “customizing” and customizable, refers both to the selection of standard image (or text) options but also refers to submitting “personalized” images (pictures, for example) and text (a signature, for example) for transfer onto an item of customizable merchandise.

Referring to FIGS. 1 and 1A, process 10 operates by having a business (10a) provide (12) a business marketing environment (12a) to a customer (14a). “Business marketing environment” refers to any medium suitable for presenting products or services and for inputting customer responses. For example, a business marketing environment may be a web-page (12b) provided from a web host provider (or server computer) and displayed on a computer display device, or a business marketing environment may be a program executed on a customer's computer (such as a game program, (12c)) and displayed on the customer's computer display device, or a business marketing environment may be printed or written materials, such an application or raffle form (12d). Process 10 presents the customizing option and the response fields on one or more “screens” to the customer. In this case, “screen” refers to a display of textual or graphic information via a computer display or via a printed form or application.

Still referring to FIG. 1, once the marketing environment screen has been provided (12), process 10 determines (14) if the customer has selected an entry point (such as selecting an active region on a web-page) or achieved a specified performance level (such as earning a specific level of points in a game program). Process 10 then presents (16) a customization option related to customizing an available item of merchandise.

For example, process 10 may present (16) customization options that include an option for the content (text or image) to be printed on the item, an option for where to print the content on the merchandise item, an option of a size (if applicable) and an option of which item to manufacture from an assortment of items. Process 10 then determines (18) if all customization selections have been completed, and if they have, presents (20) the customer with a customer question screen that requires the customer to provide a response relating to his personal information, for example, his name, his address, and his age. Process 10 then determines (22) if a specified minimum number of questions have been answered (or minimum number of responses have been provided), and if they have, process 10 uses the selection data and the response data in a delivery and data distribution process 25. An example of a minimum amount of customer data required from the customer is the customer's name and address for use in the delivery and distribution process 25.

Additional features may be incorporated into process 10. These features are shown in dotted lines on FIG. 1. For example, process 10 may include displaying (26) a graphical representation of the item of merchandise on the screen and updating (26) the displayed item based on the selection data received.

The different parties performing process 10, or portions of process 10, is shown in more detail in FIG. 1a. The business 10a, provides the business marketing environment 12b-12d. A customer 14a interacts with the marketing environment 12b-12d and provides selection data and response data that is stored on a storage medium (28a). The appropriate selection data and/or response data (28a) is then used by a manufacturer (30a) to manufacture the customized merchandise, a shipping company (32a) to deliver the customized goods selected and a billing department (34a) that bills the cost of manufacture and/or shipping to the business (10a) or the customer (14a).

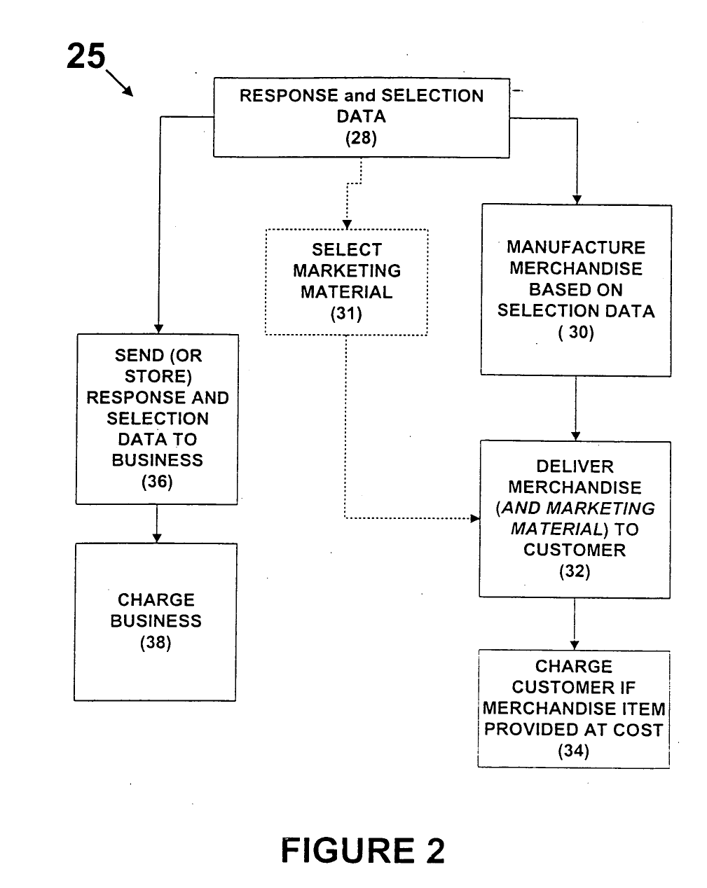

Referring to FIG. 2, a delivery and data distribution process 25 uses the response data and selection data (28) to manufacture (30) the merchandise based on the selection data and deliver (32) the merchandise to the customer based on the response data. If there is a charge to the customer for the merchandise item, process 10 includes a charge (34) to the customer for the delivered merchandise. Delivery and data distribution process 25 also includes sending (36) the response data and/or the selection data gathered during process 10 to the business providing the marketing environment. Alternatively, response and selection data are stored (36) and made available for later use by the business. Process 25 also includes charging (38) the business for the collection of the data. Charging (38) may also include charging the business for part or all of the manufacture and/or delivery of the merchandise (this would be the case where the merchandise was being provided to the customer at a reduced cost, or at no cost).

Additional features may be incorporated into process 25. These features are shown in dotted lines on FIG. 2. For example, process 25 may include selecting (31) marketing material based on the response and/or selection data. The marketing material selected may then be delivered (32) along with the manufactured merchandise, or delivered separately. Selecting (31) marketing material enables a business to target a customer based on his responses or selections, for example, selecting marketing material related to a line of sporting goods if the customer has indicated an interest in sporting goods in his/her responses and selections.

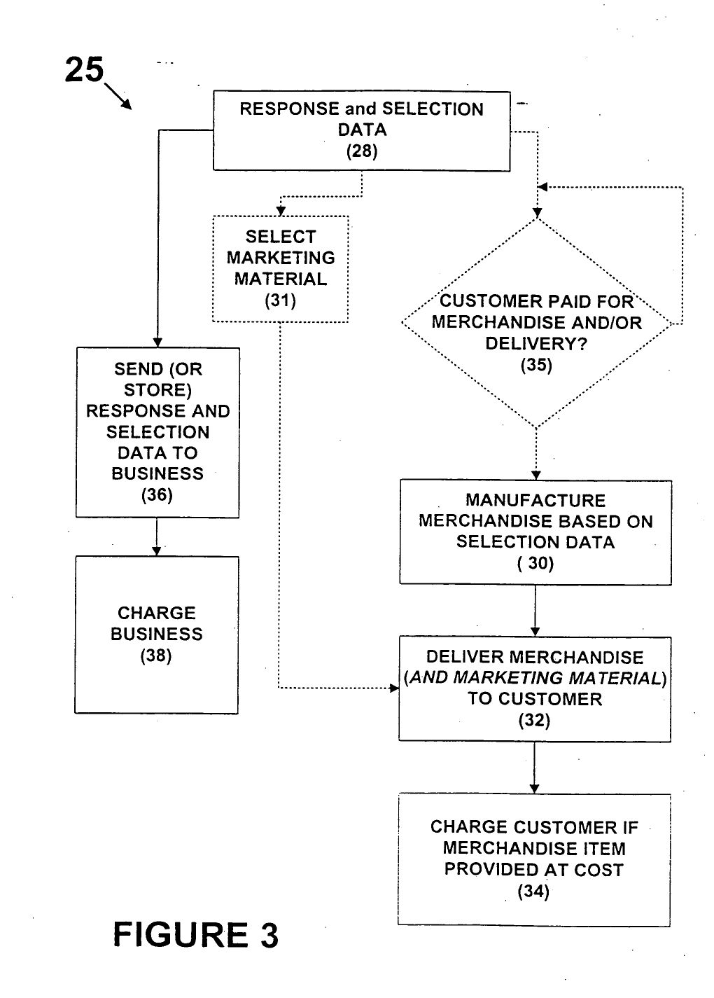

Referring to FIG. 3, a second embodiment of a delivery and data distribution process 25 is shown that incorporates additional features shown in dotted lines. In this alternate embodiment, process 25 includes determining (35) whether the customer has paid for the merchandise and/or delivery of the merchandise before completing process 25.

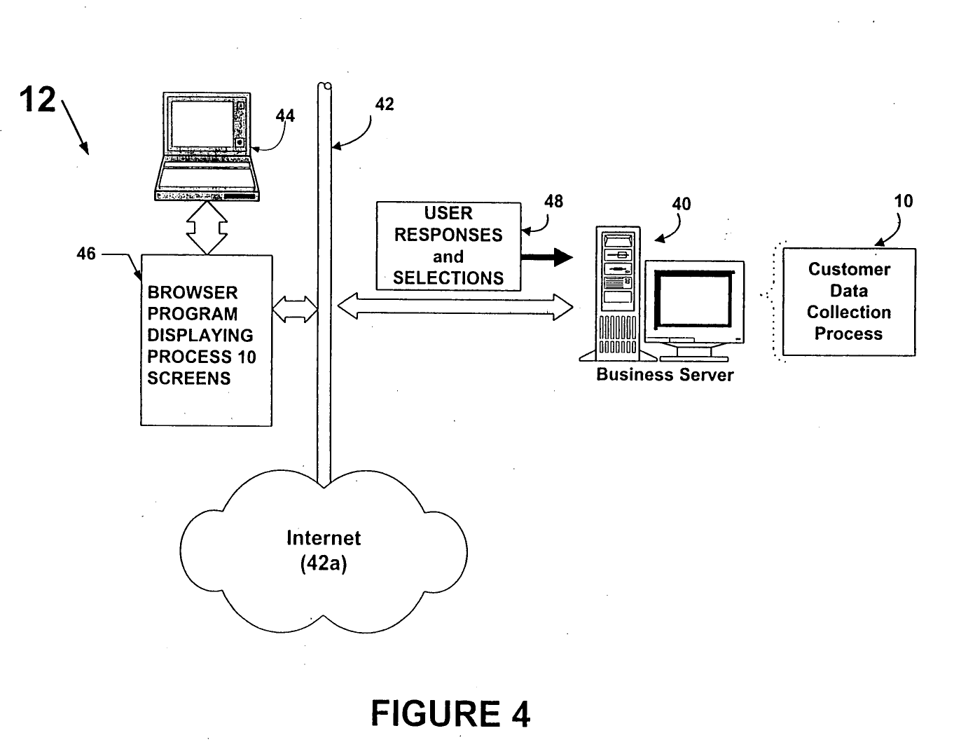

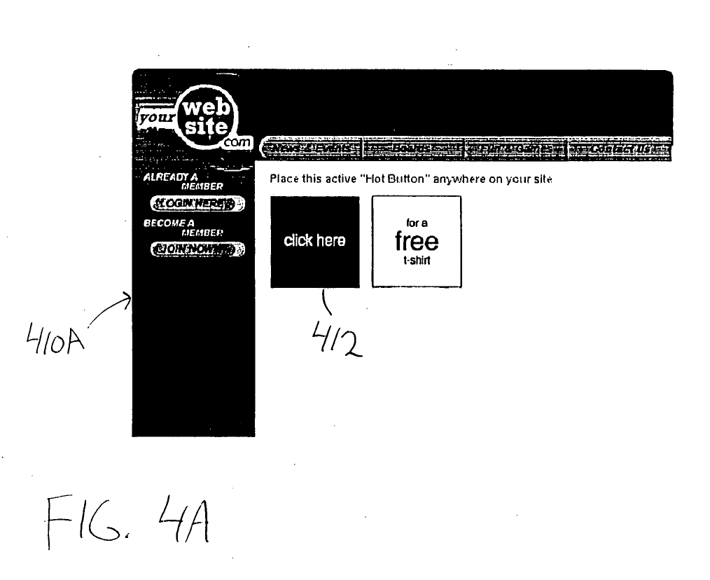

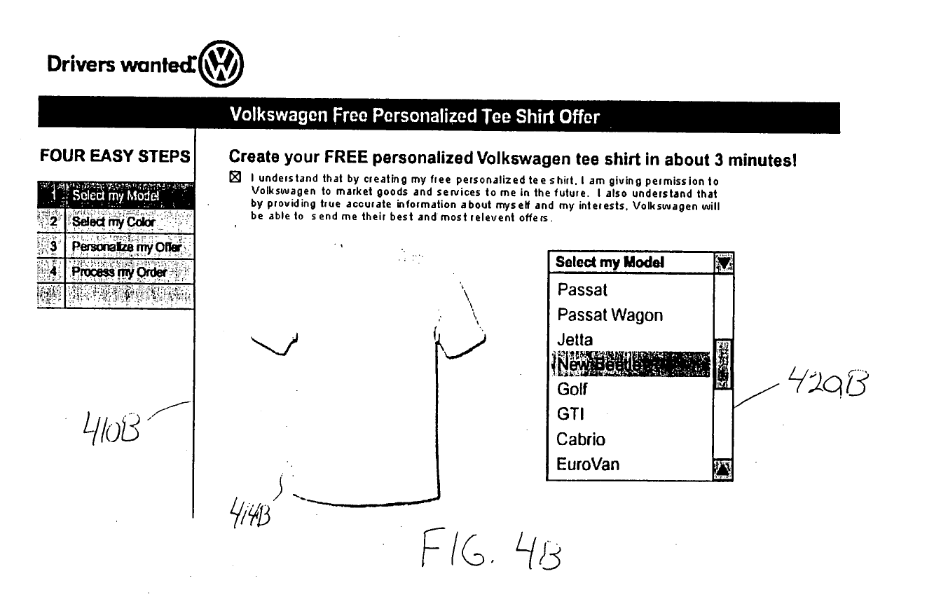

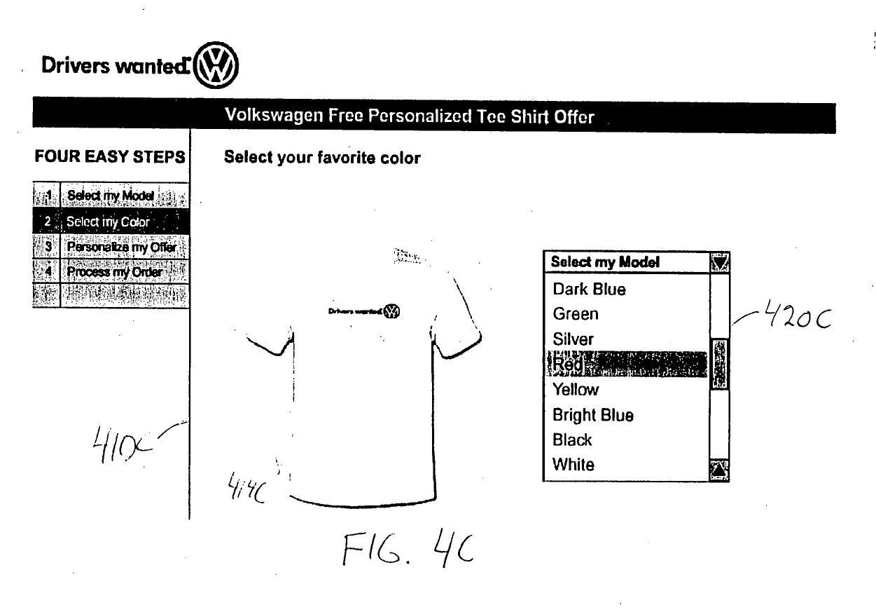

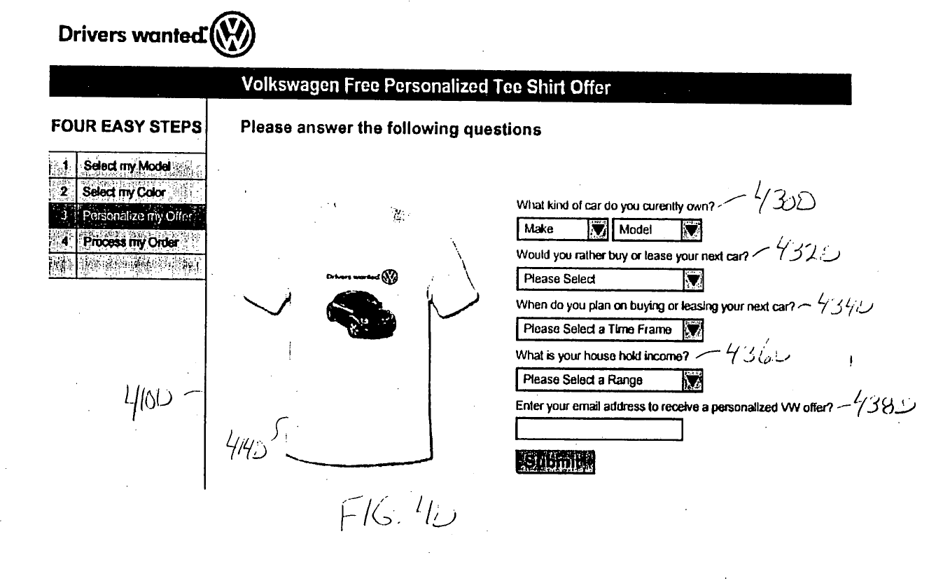

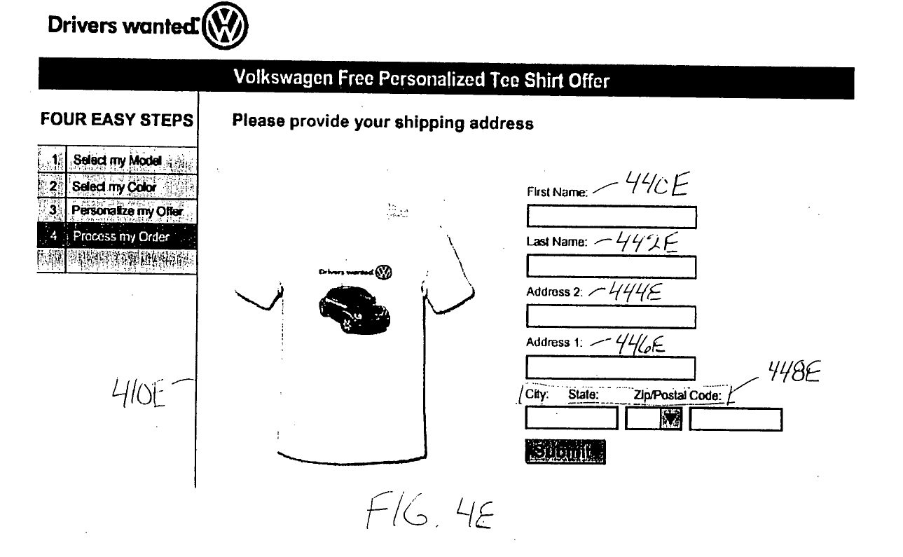

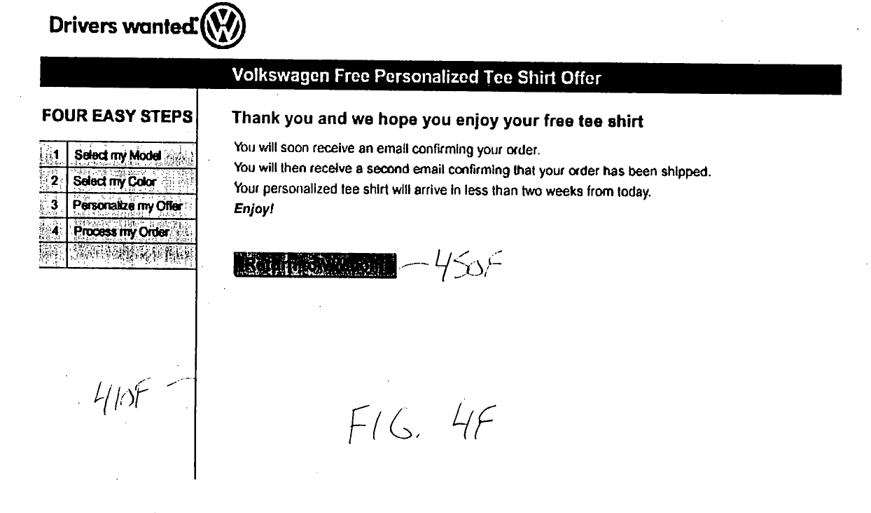

Referring to FIG. 4, an exemplary business marketing environment 12 includes a customer data collection process 10 being served from a business server computer 40 to a customer computer 44 through a computer network 42 (in this case Internet 42a). A customer “enters” business marketing environment 12 by interacting with a browser program 46 that is executing on customer computer 44 and causing the display of web-pages served from business server computer 40 on customer computer 44. The web-pages include active regions which allow data to be input, for example, textual responses or selections, and active regions that, when selected, cause the responses and selections 48 to be sent to server computer 18.

Referring to FIGS. 4A-4F, there are shown exemplary interactive web-pages 410A-410F, which are displayed during the performance of process 10. Display windows 410a-410f may be hyper-text markup language (HTML) web-pages that include HTML-defined active regions, such as “button” 412, which when selected either cause another web-page to be displayed or response information to be input to the web-page provider. Active regions 420B (see FIG. 4B) and 420C (see FIG. 4C) provide a way for a customer to make customization selections, and also cause a display area 414B-414D to display a graphical representation of the customized merchandise (in this case a T-Shirt). Response areas 430-434 (see FIG. 4D) and response areas 440-434 (see FIG. 4E) provide a way for a customer to provide response data to the web-page provider. FIG. 4F shows a final web-page screen which is displayed upon completion of the customer data collection process 10, and includes a return “button” 450F, which, when selected causes a return to the business's business marketing environment (or another web-page).

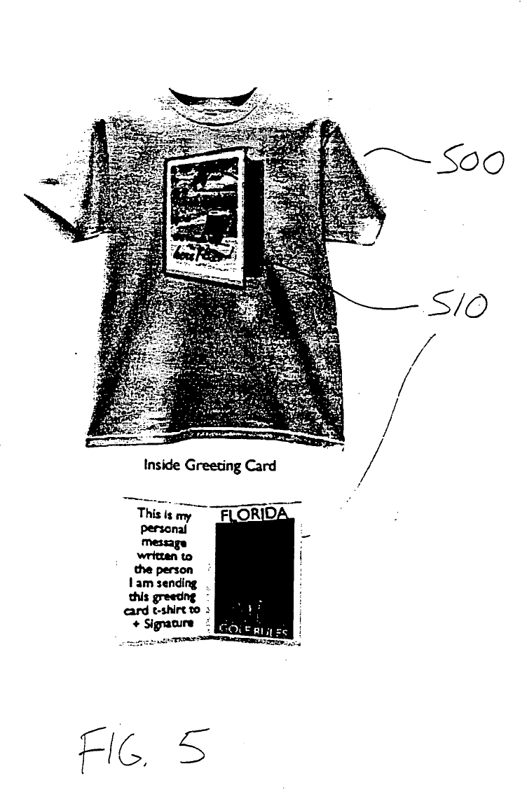

Referring to FIG. 5, an example of an item of customizable merchandise includes an apparel item 500, that includes a temporary covering (or label) 510 attached to apparel item 500. In this example, either or both apparel item 500 and covering 510 may be customized. Also, in this example, covering 510 may be attached to apparel item 500 so that the printing on apparel item 500 is completely, or partially, covered by covering 500.

Covering 510 may also be manufactured to resemble an article of clothing. For example, covering 510 might be manufactured to appear similar to a bikini top or bottom and covering a woman's image transferred on apparel item 500. Alternatively, covering 510 may be manufactured and attached as a peel-away label, or as a washable covering that is removed by one or more washings of apparel item 500. Also, more than one temporary covering (or label) 510 may be attached to apparel item 500, each covering 510 being customizable.

Process 10 may be modified to suit the marketing requirements of a business. For example, process 10 may include having a business select the customizable merchandise item (or items) that are made available during process 10. Process 10 may also include having a business select the content and configuration of customizable options, for example, where on the selected merchandise business-related information may be placed, and where and what type of personal data may be placed on the customizable item. Process 10 may also include having the business select what minimum number or type of customer questions must be answered for process 10 to complete. Process 10 also may include having the business choose the entry point into process 10, for example, the selection of a web-page screen or web-page link, the execution of a program or a specified measure of achievement by the customer (for example, a specific number of points scored during a game).

Business information may include a logo, a trademark symbol and/or sponsorship information related to a particular event.

Process 10 is not limited to use with the hardware and software of FIG. 4. It may find applicability in any computing or processing environment. Process 10 may be implemented in hardware, software, or a combination of the two. Process 10 may be implemented in computer programs executing on programmable computers or other machines that each include a processor, a storage medium readable by the processor, at least one input device, and one or more output devices.

Each computer program may be stored on a storage medium/article (e.g., CD-ROM, hard disk, or magnetic diskette) that is readable by a general or special purpose programmable computer for configuring and operating the computer when the storage medium or device is read by the computer to perform process 10. Process 10 may also be implemented as a machine-readable storage medium, configured with a computer program, where, upon execution, instructions in the computer program cause a machine to operate in accordance with process 10.

It is noted that the business marketing environment may be a web-based environment or any other environment that allows a customer to provide responses and make selections of personalizable merchandise. Business marketing environment may also refer to any type of sales environment that is appropriate for presenting the marketing interface screens, for example, a salesroom environment where a printed application, a printed form or a computer display screen may be used to present response and customization choice screens.

The invention is not limited to the specific embodiments described above. For example, we described a system having different computer systems interconnected by a computer network such as the Internet. However, the different computer systems can be integrated into a smaller number of computer systems or into a single computer system. Also, the different computer systems can be interconnected by networks other than the Internet. Furthermore, the customer data collection process 10 could be served (and stored) on a computer other than business server computer 40. For example, the business server computer 40 could provide a first web-page with a link to a second web-page, or a web-page on another computer on Internet 42a, and the second web-page could provide the link to the customer data collection process 10.

Other embodiments not described herein are also within the scope of the following claims.

1. A method comprising:
displaying a representation of a customizable merchandise item on a marketing screen, the screen having at least one response field for customer data and at least one response field for a customization option;
receiving selection data from the customer, the selection data usable for manufacturing the item;
updating the displayed representation based on the selection data; and
receiving a customer response, the response representing customer data.

2. The method of claim 1, further comprising:
manufacturing the merchandise item based on the selection data; and
delivering the item based on the response data, wherein at least one of the manufacture and delivery of the merchandise item is performed at no cost to the customer.

3. The method of claim 2, wherein before displaying the marketing screen, the customer selects an entry point into the marketing screen.

4. The method of claim 2, wherein before presenting the marketing screen the customer achieves a specified performance level.

5. The method of claim 2, wherein the selection data includes an indication of at least one of a content, a configuration, a size and a color of the item.

6. The method of claim 2, wherein the merchandise item comprises an apparel item.

7. The method of claim 6, wherein the apparel item includes at least one temporary covering, wherein at least one of the apparel item or the temporary covering is manufactured based on the selection data.

8. The method of claim 6, wherein the apparel item includes a removable greeting card attached to the apparel item.

9. The method of claim 5, further comprising:
charging a business for collecting at least one of the response data and the selection data.

10. The method of claim 2, further comprising:
charging a business for at least one of the manufacture and the delivery of the item.

11. The method of claim 1, further comprising:
charging the customer for at least one of a manufacture and a delivery of the merchandise item.

12. The method of claim 11, further comprising:
collecting the customer charge before manufacturing and delivering the item.

13. The method of claim 2, further comprising:
specifying a minimum amount of response data required from the customer before manufacturing or delivering the item.

14. The method of claim 2, wherein the marketing screen comprises an executable program performed on a computer processor.

15. The method of claim 14, wherein the program comprises a game.

16. The method of claim 14, wherein the marketing screen comprises a displayed web-page, the responses and the selections being responses to regions on the web-page.

17. The method of claim 13, wherein the marketing screen comprises a printed document, the customer providing responses and selections by filling in blank sections on the document.

18. An article comprising a machine-readable medium that stores machine-executable instructions for collection customer data, the instructions causing a machine to:
display a representation of a customizable merchandise item on a marketing screen, the screen having at least one response field for customer data and at least one response field for a customization option;
obtain selection data from the customer, the selection data usable for manufacturing the item;
update the displayed representation based on the selection data; and
obtain a customer response, the response representing customer data.

19. The article of claim 18, wherein the the merchandise item is manufactured based on the selection data and delivered based on the response data, and wherein at least one of the manufacture and delivery of the merchandise item is performed at no cost to the customer.

20. The article of claim 19, wherein before displaying the marketing screen, the customer selects an entry point into the marketing screen or achieves a specified performance level.

21. The article of claim 20, wherein the selection data includes an indication of at least one of a content, a configuration, a size and a color of the item.

22. The article of claim 21, further comprising instruction causing a machine to:
charge a business for collecting at least one of the response data and the selection data.

23. The article of claim 19, further comprising instructions causing a machine to:
charge a business for at least one of the manufacture and the delivery of the item.

24. The article of claim 18, further comprising instructions causing a machine to:
charge the customer for at least one of a manufacture and a delivery of the merchandise item.

25. The article of claim 19, wherein the marketing screen comprises an executable program performed on a computer processor.

26. The article of claim 26, wherein the program comprises a game.

27. The article of claim 26, wherein the marketing screen comprises a displayed web-page, the responses and the selections being responses to regions on the web-page.
